(19) United States
(12) Patent Application Publication
(10) Pub. No.: US 2022/0051656 A1
(43) Pub. Date: Feb. 17, 2022

(54) SYSTEM AND METHOD USING CLOUD STRUCTURES IN REAL TIME SPEECH AND TRANSLATION INVOLVING MULTIPLE LANGUAGES, CONTEXT SETTING, AND TRANSCRIPTING FEATURES

(71) Applicants: Lakshman Rathnam, Mountain View, CA (US); Robert James Firby, San Mateo, CA (US)

(72) Inventors: Lakshman Rathnam, Mountain View, CA (US); Robert James Firby, San Mateo, CA (US)

(73) Assignee: wordly, Inc., Los Altos, CA (US)

(21) Appl. No.: 16/992,489

(22) Filed: Aug. 13, 2020

(51) Int. Cl. G10L 15/00; G10L 15/26; G10L 15/34

(52) U.S. Cl. CPC G10L 15/005; G10L 15/34; G10L 15/26

(57) ABSTRACT

A system for using cloud structures in real time speech and translation involving multiple languages is provided. The system comprises a processor, a memory, and an application stored in the memory that when executed on the processor receives audio content in a first spoken language from a first speaking device. The system also receives a first language preference from a first client device, the first language preference differing from the spoken language. The system also receives a second language preference from a second client device, the second language preference differing from the spoken language. The system also transmits the audio content and the language preferences to at least one translation engine and receives the audio content from the engine translated into the first and second languages. The system also sends the audio content to the client devices translated into their respective preferred languages.

### CROSS REFERENCE TO RELATED APPLICATIONS

The present non-provisional patent application is related to U.S. Provisional Patent Application No. 62/877,013 filed Jul. 22, 2019, is related to U.S. Provisional Patent Application No. 62/885,892 filed Aug. 13, 2019, and is related to U.S. Provisional Patent Application No. 62/897,936 filed Sep. 9, 2019, all of the contents of which are included herein in their entirety.

### FIELD OF THE INVENTION

The present disclosure is in the field of language translation and transcription of translated spoken content. More particularly, the present disclosure provides systems and methods of simultaneously translating, via cloud-based technology, spoken content from one language to many languages, providing the translated content in both audio and text format, adjusting the translation for context of the interaction, and building transcripts of translated material that may be annotated, summarized, and tagged for future commenting and correction as necessary.

### BACKGROUND

Large business entities, law, consulting, and accounting firms, and non-governmental (NGO) organizations are now global in scope and have physical presences in many countries. Persons affiliated with these institutions may speak many languages and must communicate with each other regularly with confidential information exchanged. Conferences and meetings involving many participants are routine and may involve persons speaking and exchanging material in multiple languages.

Translation technology currently provides primarily bilateral language translation. Translation is often disjointed and inaccurate. Translation results are often awkward and lacking context. Translation engines typically do not handle idiomatic expressions well and cannot recognize internal jargon common to organizations, professions, and industries. Transcripts generated by such translation consequently may be clunky and unwieldy and therefore be of less value to active participants and parties subsequently reading the transcripts.

### BRIEF DESCRIPTION OF THE DRAWING

FIG. 1 is a block diagram of a system of using a cloud structure in real time speech and translation involving multiple languages according to an embodiment of the present disclosure.

### DETAILED DESCRIPTION

Systems and methods described herein provide for near instantaneous translation of spoken voice content in many languages in settings involving multiple participants, themselves often speaking many languages. A voice translation may be accompanied by a text transcription of the spoken content. As a participant hears the speaker's words in the language of the participant's choice, text of the spoken content is displayed on the participant's viewing screen in the language of the participant's choice. In an embodiment, the text may be simultaneously displayed for the participant in both the speaker's own language and in the language of the participant's choice.

Features are also provided herein that may enable participants to access a transcript as it is being dynamically created while presenters or speakers are speaking. Participants may provide contributions including summaries, annotations, and highlighting to provide context and broaden the overall value of the transcript and conference. Participants may also selectively submit corrections to material recorded in transcripts. Nonverbal sounds occurring during a conference are additionally identified and added to the transcript to provide further context.

As a presentation or meeting is progressing, a participant chooses the language he or she wishes to hear and view transcriptions in independent of a language the presenter has chosen for speaking. Many parties, both presenters and participants, may participate using various languages. Many languages may be accommodated simultaneously in a single group conversation. Participants may use their own chosen devices with no need to install specialized software.

As a benefit, extended meetings may be shorter and fewer through use of the systems and methods provided herein. Meetings may as a result have an improved overall tenor as the flow of a meeting is interrupted less frequently due to language problems and the need for clarifications and corrections. Misunderstandings among participants may be reduced and less serious.

Participants that are not fluent in other participants' languages are less likely to be stigmatized, penalized, or marginalized. Invited persons who might otherwise be less inclined to participate because of language differences may participate in their own native language, enriching their experience and enabling them to add greater value.

The value of participation by such previously shy participants to others is also enhanced as these heretofore hesitant participants can read the meeting transcript in their chosen language in near real time while hearing and speaking in their chosen language as well. The need for special headsets, sound booths, and other equipment is eliminated.

Systems and methods use advanced natural language processing and artificial intelligence. The speaker speaks in his/her chosen language into a microphone connected to a device using iOS, Android, or other operating system. The speaker's device and/or a server executes an application provided herein. Software associated with the application transmits the speech to a cloud platform provided herein where artificial intelligence associated with the software translates the speech into many different languages. The software provides the transcript services provided herein.

Participants join the session using an attendee application provided herein. Attendees select their desired language. Attendees receive the text and audio of the speech as well as transcript access support services in near real time in their own selected language.

Functionality is further provided that may significantly enhance the quality of translation and therefore the participant experience and overall value of the conference or meeting. Intelligent back end systems may improve translation and transcription by selectively using multiple translation engines, in some cases simultaneously, to produce a desired result.

Translation engines are commercially available, accessible on a cloud-provided basis, and be selectively drawn upon to contribute. The system may use two or more translation engines simultaneously. Depending at least on factors including the languages of speakers and attendees, the subject matter of the discussion, the voice characteristics and demonstrated listening abilities and attention levels of participants, and technical quality of transmission, the system may select a specific one, two or more translation engines for use.

One translation engine may function as a primary source of translation while a second translation engine is brought in as a supplementary source to confirm translation produced by the first engine or step in when the first engine encounters difficulty. In other embodiments, two or more translation engines may simultaneously perform full translation.

Functionality provided herein that executes in the cloud, on the server, and/or on the speaker's device may instantaneously determine which translation and transcript version are more accurate and appropriate at any given point in the session. The system may toggle between the multiple translation engines in use in producing the best possible result for speakers and participants based on their selected languages and the other factors listed above as well as their transcript needs.

A model may effectively be built of translation based on the specific factors mentioned above as well as number and location of participants and complexity and confidentiality of subject matter and further based on strengths and weaknesses of available translation engines. The model may be built and adjusted on a sentence by sentence basis and may dynamically choose which translation engine or combination thereof to use.

Context may be established and dynamically adjusted as a session proceeds. Context of captured and translated material may be carried across speakers and languages and from one sentence to the next. This action may improve quality of translation, support continuity of a passage, and provide greater value, especially to participants not speaking the language of a presenter.

Individual portions of captured speech are not analyzed and translated in isolation from one another but instead in context of what has been said previously. As noted, carrying of context may occur across speakers such that during a session, for example a panel discussion or conference call, context may be carried forward, broadened out, and refined based on the spoken contribution of multiple speakers. The system may blend the context of each speaker's content into a single group context such that a composite context is produced of broader value to all participants.

A glossary of terms may be developed during or after a session. The glossary may draw upon a previously created glossary of terms. The system may adaptively change a glossary during a session. The system may detect and extract key terms and keywords from spoken content to build and adjust a glossary.

The glossary and contexts developed may incorporate preferred interpretations of some proprietary or unique terms and spoken phrases and passages. These may be created and relied upon in performing translation, developing context, and creating transcripts for various audiences. Organizations commonly create and use acronyms and other terms to facilitate and expedite internal communications. Glossaries for specific participants, groups, and organizations could therefore be built, stored and drawn upon as needed.

Services are provided for building transcripts as a session is ongoing and afterward. Transcripts may also be created and continuously refined after a session has ended. Transcript text is displayed on monitors of parties in their chosen languages. When a participant, whether speaker or listener, sees what he/she believes is a translation or other error in the transcript, the participant may tag or highlight the error for later discussion and correction.

Participants are enabled, as the session is ongoing and translation is taking place on a live or delayed basis, to provide tagging of potentially erroneous words or passages. The participant may also enter corrections to the transcript during the session which may automatically be entered into an official or secondary transcript or held for later review and official entry by others.

Transcripts may be developed in multiple languages as speakers make presentations and participants provided comments and corrections. Participants may annotate transcripts while the transcripts are being created. Participants may mark sections of a transcript that they find interesting or noteworthy. A real time running summary may be generated for participants unable to devote full attention to a conference, for example participants arriving late or distracted by other matters during the conference.

The system may be configured by authorized participants to isolate selected keywords to capture passages and highlight other content of interest. When there are multiple speakers, for example during a panel discussion or conference call, the transcript identifies the speaker. Summaries limited to a particular speaker's contribution may be generated while other speakers' contributions would not be included or would be limited.

The transcript may rely on previously developed glossaries. In an embodiment, a first transcript of a conference may use a glossary appropriate for internal use within an organization, and a second transcript of the same conference may use a general glossary more suited for public viewers of the transcript.

Systems and methods also provide for non-verbal sounds to be identified, captured, and highlighted in transcripts. Laughter and applause, for example, may be identified by the system and highlighted in a transcript, providing further context.

In an embodiment, a system for using cloud structures in real time speech and translation involving multiple languages is provided. The system comprises a processor, a memory, and an application stored in the memory that when executed on the processor receives audio content in a first spoken language from a first speaking device. The system also receives a first language preference from a first client device, the first language preference differing from the spoken language.

The system also receives a second language preference from a second client device, the second language preference differing from the spoken language. The system also transmits the audio content and the language preferences to at least one translation engine. The system also receives the audio content from the engine translated into the first and second languages and sends the audio content to the client devices translated into their respective preferred languages.

The application selectively blends translated content provided by the first translation engine with translated content provided by the second translation engine. It blends such translated content based on factors comprising at least one of the first spoken language and the first and second language preferences, subject matter of the content, voice characteristics of the spoken audio content, demonstrated listening abilities and attention levels of users of the first and second client devices, and technical quality of transmission. The application dynamically builds a model of translation based at least on at least one of the factors, on locations of users of the client devices, and on observed attributes of the translation engines.

In another embodiment, a method for using cloud structures in real time speech and translation involving multiple languages. The method comprises a computer receiving a first portion of audio content spoken in a first language. The method also comprises the computer receiving a second portion of audio content spoken in a second language, the second portion spoken after the first portion. The method also comprises the computer receiving a first translation of the first portion into a third language. The method also comprises the computer establishing a context based on at least the first translation. The method also comprises the computer receiving a second translation of the second portion into the third language. The method also comprises the computer adjusting the context based on at least the second translation.

Actions of establishing and adjusting the context are based on factors comprising at least one of subject matter of the first and second portions, settings in which the portions are spoken, audiences of the portions including at least one client device requesting translation into the third language, and cultural considerations of users of the at least one client device. The factors further include cultural and linguistic nuances associated with translation of the first language to the third language and translation of the second language to the third language.

In yet another embodiment, a system for using cloud structures in real time speech and translation involving multiple languages and transcript development is provided. The system comprises a processor, a memory, and an application stored in the memory that when executed on the processor receives audio content comprising human speech spoken in a first language. The system also translates the content into a second language and displays the translated content in a transcript displayed on a client device viewable by a user speaking the second language.

The system also receives at least one tag in the translated content placed by the client device, the tag associated with a portion of the content. The system also receives commentary associated with the tag, the commentary alleging an error in the portion of the content. The system also corrects the portion of the content in the transcript in accordance with the commentary.

The application verifies the commentary prior to correcting the portion in the transcript. The error may allege concerns at least one of translation, contextual issues, and idiomatic issues.

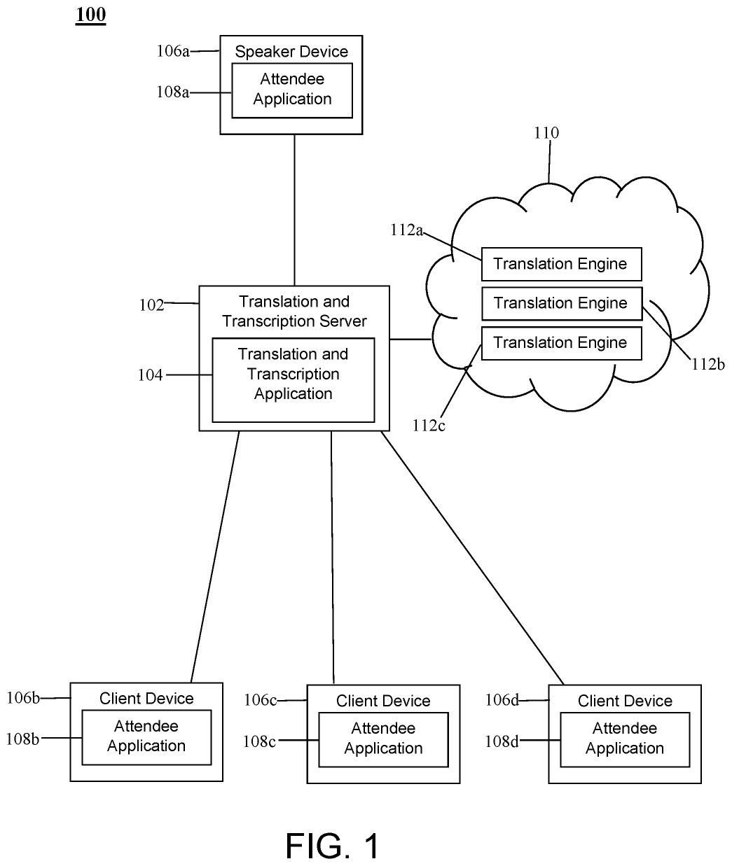

Turning to the figure, FIG. 1 is a block diagram of a system using cloud structures in real time speech and translation involving multiple languages, context setting, and transcript development features in accordance with an embodiment of the present disclosure. FIG. 1 depicts components and interactions of a system 100.

The system 100 comprises a translation and transcription server 102 and a translation and transcription application 104, components referred to for brevity as the server 102 and the application 104. The application 102 executes much of the functionality described herein.

The system 100 also comprises a speaker device 106a and client devices 106b-d. These components may be identical as the speaker device 106a and client devices 106b-d may be interchangeable as may the roles of their users. A user of the speaker device 106a may be a speaker or conference leader on one day and on another day may be an ordinary attendee. The speaker device 106a and client devices 106b-d have different names to distinguish their users but their physical makeup may be the same, such as a mobile device or desktop computer with hardware functionality to perform the tasks described herein.

The system 100 also comprises the attendee application 108a-d that executes on the speaker device 106a and client devices 106b-d. As speaker and participant roles may be interchangeable from one day to the next as described briefly above, the software executing on the speaker device 106a and client devices 106b-d is the same or similar depending on whether a person is a speaker or participant.

The system 100 also includes the cloud 110, a plurality of computing resources including computing power with physical resources widely dispersed and with on-demand availability. The cloud includes translation engines 112a-c that may be drawn upon by the application 104 or the attendee application 108a executing on the speaker device 106a.

What is claimed is:

1. A system for using cloud structures in real time speech and translation involving multiple languages, comprising:
a processor;
a memory; and
an application stored in the memory that when executed on the processor:
receives audio content in a first spoken language from a first speaking device,
receives a first language preference from a first client device, the first language preference differing from the spoken language,
receives a second language preference from a second client device, the second language preference differing from the spoken language,
transmits the audio content and the language preferences to at least one translation engine,
receives the audio content from the engine translated into the first and second languages, and
sends the audio content to the client devices translated into their respective preferred languages,
wherein the at least one translation engine is cloud-based,
wherein the client devices receive the audio content translated into their respective languages in spoken audio format and in text format, and
wherein the application further develops context for the audio content.

2. The system of claim 1, wherein the application further carries the context forward across content provided by additional speaking devices and spoken languages beyond the first spoken language.

3. The system of claim 1, wherein the application maintains a running transcript of the spoken audio content and permits client devices to submit annotations to the transcript.

4. The system of claim 3, wherein the submitted annotations at least one of summarize, explain, add to, and question portions of transcripts highlighted by the annotation.

5. The system of claim 1, wherein the application relies on a cloud-based second translation engine to supplement translation actions of a first translation engine.

6. The system of claim 5, wherein the application selectively blends translated content provided by the first translation engine with translated content provided by the second translation engine.

7. The system of claim 6, wherein the application selectively blends translated content based on factors comprising at least one of the first spoken language and the first and second language preferences, subject matter of the content, voice characteristics of the spoken audio content, demonstrated listening abilities and attention levels of users of the first and second client devices, and technical quality of transmission.

8. The system of claim 7, wherein the application dynamically builds a model of translation based at least on at least one of the factors, on locations of users of the client devices, and on observed attributes of the translation engines.

9. A method for using cloud structures in real time speech and translation involving multiple languages, comprising:
a computer receiving a first portion of audio content spoken in a first language;
the computer receiving a second portion of audio content spoken in a second language, the second portion spoken after the first portion;
the computer receiving a first translation of the first portion into a third language;
the computer establishing a context based on at least the first translation;
the computer receiving a second translation of the second portion into the third language; and
the computer adjusting the context based on at least the second translation.

10. The method of claim 9, wherein actions of establishing and adjusting the context are based on factors comprising at least one of subject matter of the first and second portions, settings in which the portions are spoken, audiences of the portions including at least one client device requesting translation into the third language, and cultural considerations of users of the at least one client device.

11. The method of claim 10, wherein the factors further include cultural and linguistic nuances associated with translation of the first language to the third language and translation of the second language to the third language.

12. The method of claim 9, further comprising the computer receiving the translations from at least one cloud-based translation engine.

13. The method of claim 12, further comprising the computer simultaneously requesting translation of a single body of content from at least two cloud-based translation engines and selectively blending translation results received therefrom.

14. The method of claim 9, further comprising the computer carrying the context forward with further adjustments based on additional spoken content.

15. A system for using cloud structures in real time speech and translation involving multiple languages and transcript development, comprising:
a processor;
a memory; and
an application stored in the memory that when executed on the processor:
receives audio content comprising human speech spoken in a first language,
translates the content into a second language,
displays the translated content in a transcript displayed on a client device viewable by a user speaking the second language
receives at least one tag in the translated content placed by the client device, the tag associated with a portion of the content,
receives commentary associated with the tag, the commentary alleging an error in the portion of the content,
corrects the portion of the content in the transcript in accordance with the commentary.

16. The system of claim 15, wherein the application verifies the commentary prior to correcting the portion in the transcript.

17. The system of claim 15, wherein users of a plurality of client devices hearing the audio content and reading the transcript additionally provide summaries, annotations, and highlighting to the transcript.

18. The system of claim 15, wherein the error alleged concerns at least one of translation, contextual issues, and idiomatic issues.

19. The system of claim 15, wherein the application sends the audio content to at least a first cloud-based translation engine for the translation.

20. The system of claim 19, wherein the application further sends the audio content to a second cloud-based translation engine for the translation and selectively blends translated content provided by the first translation engine with translated content provided by the second translation engine.
